(19) United States
(12) Patent Application Publication
(10) Pub. No.: US 2025/0073912 A1
(43) Pub. Date: Mar. 6, 2025

(54) MULTI-STAGE HOLE MACHINING END-EFFECTOR FOR COBOT SYSTEMS

(71) Applicants: Khalifa University of Science and Technology, Abu Dhabi (AE); Strata Manufacturing, Abu Dhabi (AE)

(72) Inventors: Laith ABUASSI, Abu Dhabi (AE); Abdulla AYYAD, Abu Dhabi (AE); Mohammed RAMADAN, Abu Dhabi (AE); Yahya AL-ZWEIRI, Abu Dhabi (AE); John Gordon Munro FERGUSON, Abu Dhabi (AE); Abdelqader ABUSAFIEH, Abu Dhabi (AE)

(21) Appl. No.: 18/460,533

(22) Filed: Sep. 2, 2023

(51) Int. Cl. B25J 11/00; B23B 35/00

(52) U.S. Cl. CPC B25J 11/0055; B23B 35/00

(57) ABSTRACT

A cooperative robot (Cobot) system can perform multiple machining tasks. For example, a Cobot system can include a machining end-effector. The machining end-effector can include a main part. The main part can include a machining bit extendable from the main part. The main part can also include a motor for rotation the machining bit. The machining end-effector can also include a subpart. The subpart can include a linear guiding mechanism. The linear guiding mechanism can passively align the machining bit by generating a reaction torque that utilizes a compliance of the Cobot system.

### BACKGROUND OF THE INVENTION

Industrial robots play an important role in mass production and large assembly lines in manufacturing applications. Industrial robots can perform numerous repetitive tasks that are critical to many industries. But industrial robots can usually be confined to a particular working area within fence guarding and can be prohibited from operating outside a designated area to prevent any harm to human operators. For safety reasons, industrial robots can be deactivated when exchanging materials with humans or for any other type of interaction with humans. A separation between industrial robots and human operators can limit the functionality and cost-effectiveness of automated robotic solutions.

The development of Cobots can address various issues, such as the separation between industrial robots and human operators, that prevent robots from working effectively in industrial settings. A Cobot, short for Collaborative Robot, can be a new type of robot that works alongside humans to perform tasks in a collaborative manner within a shared workspace. Cobots can be designed to be more flexible, more intelligent, and/or safer than other types of industrial robots. Benefits of using Cobots can include improved quality and productivity. Cobots can remain efficient regardless of hours worked while providing production stability in terms of precision and consistency. A rise in the use of Cobots can be an important component of smart manufacturing. An Industry 4.0 paradigm can be expected to lead to the development of more popular collaborative applications, improving efficiency and driving new discoveries in automation. In addition, cobot systems can be considered an important component in a fourth industrial revolution as cobot systems can automate various industrial processes without costly or complex infrastructure. Cobot systems can be a suitable choice for small industrial start-ups.

But, using Cobot systems to complete tasks normally performed by traditional robots can be difficult to achieve, under conditions where both high precision and large payloads can be important. Such conditions can challenge Cobot systems to work near designed boundary conditions due to inherent low stiffness and high compliance properties of Cobots. Consistently working near the designed boundary conditions can lead to significant degradation in achieved precision and repeatability, which can hinger implementation of Cobot systems in big industrial processes.

The high compliance and low stiffness of Cobots can make Cobot systems more susceptible to external disturbances and environmental factors than traditional robots, which can negatively impact performance and result in increased variability in outputs. In addition, positioning accuracy, which can be essential in industrial applications, of Cobot systems can be altered by an attached payload. For instance, large errors may occur when manipulating heavy parts in a precise assembly process, or when positioning a large machine force precisely within highly dynamic environments, such as when a Cobot system performs sub-machining tasks on large aircraft workpieces that can be fixed in different orientations.

### BRIEF SUMMARY OF THE INVENTION

A cooperative robot (Cobot) system can perform multiple machining tasks. For example, a Cobot system described herein can include a machining end-effectors. The machining end-effector can include a main part. The main part can include a machining bit. The machining bit can extend from the main part. The main part can also include a motor. The motor can rotate the machining bit. The machining end-effector can also include a subpart. The subpart can include a linear guiding mechanism. The linear guiding mechanism can passively align the machining bit by generating a reaction torque that utilizes a compliance of the Cobot system.

In another example, a method for machining a specified hole with a Cobot system described herein can include localizing a workpiece. The method can also include localizing a specified hole on the workpiece. Additionally, the method can include aligning a machining bit of a machining end-effector with an axis of the specified hole. The method can further include passively aligning the machining bit using a linear guidance system of the machining end-effector. The method can include advancing the machining bit towards the specified hole. The method can further include completing at least one machining task to the specified hole.

### BRIEF DESCRIPTION OF THE DRAWINGS

FIG. 1 is a flow chart of an example of a process for installation of a nutplate according to some aspects of the present disclosure.

FIG. 2 is an image of a perspective view of a workpiece with holes for machining tasks according to some aspects of the present disclosure.

FIG. 3 is a schematic of a perspective view of a multi-functional cobot system environment according to some aspects of the present disclosure.

FIG. 4 is an image of a perspective view of a deburring end effector for a Cobot system according to some aspects of the present disclosure.

FIG. 5 is an additional image of a perspective view of a deburring end effector for a Cobot system according to some aspects of the present disclosure.

FIG. 6 is an electro-mechanical schematic of a deburring end effector for a Cobot system according to some aspects of the present disclosure.

FIG. 7 is a schematic of passive self-alignment features of a deburring end effector for a Cobot system according to some aspects of the present disclosure.

FIG. 8 is an image of a perspective view of a painting end effector for a Cobot system according to some aspects of the present disclosure.

FIG. 9 is an additional image of a perspective view of a painting end effector for a Cobot system according to some aspects of the present disclosure.

FIG. 10 is an image of a side view of a painting end effector for a Cobot system for highlighting electro-mechanical components according to some aspects of the present disclosure.

FIG. 11 is an electro-mechanical schematic of a painting end effector for a Cobot system according to some aspects of the present disclosure.

FIG. 12 is an image of a perspective view of a Cobot system according to some aspects of the present disclosure.

FIG. 13 is an image of a front view of three holes deburred by a deburring end effector of a Cobot system according to some aspects of the present disclosure.

FIG. 14 is an image of a front view of a hole deburred by a deburring end effector of a Cobot system that highlights a chamfer diameter according to some aspects of the present disclosure.

FIG. 15 is a flow chart of an example of a process for deburring pilot holes of a workpiece using a Cobot system according to some aspects of the present disclosure.

FIG. 16 is an image of a Cobot system at an initial location according to some aspects of the present disclosure.

FIG. 17 is an image of a Cobot system after autonomous navigation to a workpiece location according to some aspects of the present disclosure.

FIG. 18 is an image of a Cobot system loading a deburring end effector according to some aspects of the present disclosure.

FIG. 19 is an image depicting a deburring end effector in an initial pose prior to workpiece localization according to some aspects of the present disclosure.

FIG. 20 is an image depicting a localization of a workpiece according to some aspects of the present disclosure.

FIG. 21 is a flow chart of an example of a process for painting pilot holes of a workpiece using a Cobot system according to some aspects of the present disclosure.

FIG. 22 is an image of a Cobot system as the Cobot system loads a painting end-effector according to some aspects of the present disclosure.

FIG. 23 is an image depicting an alignment of a painting end effector with a target hole by a manipulator of a Cobot system according to some aspects of the present disclosure.

FIG. 24 is an image of an inside of a hole painted by a painting end effector of a Cobot system according to some aspects of the present disclosure.

FIG. 25 is a block diagram of an example Cobot computing controller for controlling a Cobot system as the Cobot system completes manufacturing tasks according to some aspects of the present disclosure.

FIG. 26 is an image of a machining end-effector applying a machining process to a pre-drilled hole of a workpiece according to some aspects of the present disclosure.

FIG. 27 is an image of a main part of a machining end-effector applying a machining process to a pre-drilled hole of a workpiece according to some aspects of the present disclosure.

FIG. 28 is a flow chart diagram of a machining end-effector applying a machining process to a pre-drilled hole of a workpiece according to some aspects of the present disclosure.

FIG. 29 is a flow chart diagram depicting a variety of machining processes performed by a machining end-effector to a pre-drilled hole of a workpiece according to some aspects of the present disclosure.

### DETAILED DESCRIPTION OF THE INVENTION

Certain aspects and examples of the present disclosure relate to a multi-purpose fully automated Cobot system with customized end-effector designs for performing tasks such as deburring and/or painting for precision machining. The fully automated Cobot system can include an autonomous multipurpose mobile Cobot capable of multitasking machining operations such as deburring and/or painting. An autonomous mobility of the Cobot system can enable machining operations on large workpieces across different factory areas without a dedicated set-up. A framework associated with the Cobot system can present intelligent perception, navigation, and control algorithms for full autonomy and precise machining for large-scale manufacturing operations. Experimental results of machining operations using the Cobot system exhibit a standard deviation for machining operation parameters on the order of 0.01 mm.

A customized end-effector design can establish a coupling stage between the Cobot system and a workpiece during a machining process. The coupling stage can allow the Cobot system to perform critical post-machining processes on pre-drilled holes using a machine vision system. The end-effector design can help the Cobot system achieve accurate and highly repeatable machining results that can meet industry standards such as standards for the automotive and aerospace sectors.

The customized end-effector can use a vision system to guide a Cobot directly towards pre-drilled holes that are located in a workpiece. A mechanical design of the customized end-effector can include two parts referred to as a main part and a subpart. The two parts can slide relative to each other along one axis through a linear guidance mechanism. A distance between the two parts can be continuously measured by a displacement sensor, such as a linear potentiometer. The displacement sensor can be used to help ensure that the distance does not exceed a predetermined maximum value called a default distance. Pre-loaded compression springs can be embedded between the two parts around metal rods of the linear guidance mechanism. The pre-loaded compression springs can ensure a default compression state between the main part and the subpart with a default maximum separation distance.

The main part of the customized end-effector can be fixed on a tool flange of the Cobot and can house the vision system and a spindle motor with an attached machining bit. The subpart can include either a passive anti-slip rubber pad or a pneumatically controlled flat vacuum suction cup with anti-slip treatment. Both the rubber pad and the vacuum suction cup can permit a clamping force between the subpart and workpiece surfaces. The clamping force can arise due to a pushing force generated by the Cobot as the Cobot performs a hole post-machining process after localization. Both the anti-slip rubber pad and the vacuum suction cup can suppress system vibration for stable performance.

The linear guidance mechanism can exploit an actuation force of the Cobot to drive the spindle motor that can be attached to the machining bit. The linear guidance mechanism can add more rigidity to a dynamic interaction between the customized end-effector and the workpiece and can control a depth of the machining bit with respect to the workpiece. A local positioning reference frame starting at a front surface of the workpiece can be defined by combining the Cobot's driving force with an ability of the customized end-effector to precisely measure machining depth. The machining process can be executed on front and back surfaces of the workpiece or at a depth in between the surfaces, for example, in a multistage manner for precise and repeatable machining results. Exploiting the Cobot's actuation force can eliminate a use of a separate actuating system. Removing the separate actuating system can reduce a weight of the end-effector, which can improve accuracy and repeatability in localization. Simultaneous monitoring of a Cobot insertion force and depth of the machining bit using the displacement sensor can help avoid a wrong insertion scenario.

Vibrations can present a challenge associated with a use of Cobot systems for machining processes. As Cobots can be equipped with compliant joints having relatively low stiffness, an improper dynamic interaction can occur between the Cobot and a fixed workpiece during the machining process. The improper dynamic interaction can occur because the machining bit can have two simultaneous motions: a high-speed rotational motion generated by the spindle motor and a low-speed linear feeding motion.

The dynamic interaction between Cobot joints and unsuppressed vibrations can lead to an undesired relative motion between the machining bit and a center of a hole being processed. The relative motion can generate an accumulated misalignment during machining bit insertion resulting in inaccurate machining results.

The main part and the subpart of the customized end-effector can move relative to each other only along a single axis, such as a z axis, and the distance between the two parts can be continuously measured by the displacement sensor and can be maintained below a maximum separation distance (e.g., z₀). The displacement sensor can be a linear potentiometer. Motion along the z axis can be mechanically guided by multiple linear sliders. For example, an arrangement of two linear sliders aligned parallel to the z axis and perpendicular to each other can prevent relative motion between the main part and subpart along x and y directions.

An array of compression springs with internal stainless-steel rods can be placed between the main part and subpart in a spring-loaded position. The metal rods can be fixed at the subpart and slide through linear bearings embedded in the main part. Initially, the subpart can be in an initial or home position. A separation distance can be defined as zero when the subpart is in the home position. As the main part and the subpart are placed in a compression configuration, a mechanical stopper can act to ensure that the separation distance does not exceed a default position, z₀. The mechanical stopper can be embedded on an opposite end of the metal rods. After completing a machining process, four compression spring-loaded rods in a linear guiding mechanism can return the subpart to the home position.

The main part can be fixed to a cobot main center point and can house the spindle motor with the machining bit, a stationary portion of the linear potentiometer, and all electrical and electronic components of the customized end-effector. The subpart can include the anti-slip rubber pad or vacuum suction cup. The anti-slip rubber pad or the vacuum suction cup can create a clamping force between the Cobot system and the workpiece to eliminate planar slipping motion and suppress any machining vibration.

The main part and the subpart can be manufactured from high-grade aluminum material, producing a rigid structure and low-weight end-effector. Minimizing weight of the end-effector can be important as weight can adversely affect positioning accuracy of the Cobot system.

The customized end-effector can be designed to advance the spindle motor towards the workpiece via a linear guide mechanism using the Cobot pushing force. The linear guide mechanism can include linear sliders accompanied by compression springs that allow a transmission of the Cobot pushing force to execute a machining process without implementing a separate linear actuation system. The customized end-effector can include a rubber mount attached to a tip of the end-effector that can govern an interaction between the end-effector and the workpiece. The rubber mount can minimize slippage and suppress mechanical vibrations, leading to a more stable motion and precise machining results.

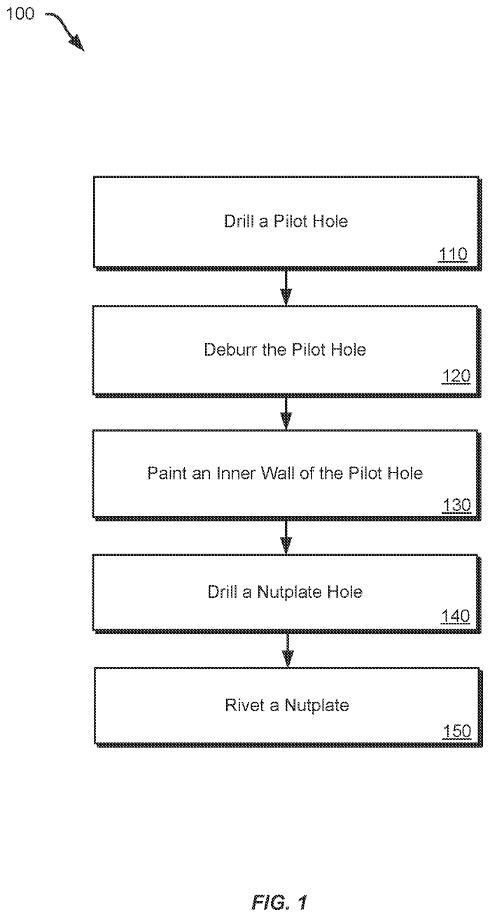

Airplanes, as well as other aerospace components can feature nutplates. Nutplates can be assemblies that include two unthreaded holes and a single-threaded hole. The unthreaded holes can be used to install the nutplates, while threaded holes can support threaded bolts or rods. Installing the nutplates can be very time-consuming and challenging due to an amount of torque, high precision, and large number of nutplates involved. Prior to attaching the nutplates, a preparation process for a workpiece may be beneficial. FIG. 1 is a flow chart of an example of a process 100 for installation of a nutplate according to some aspects of the present disclosure.

At block 110, the process 100 involves drilling pilot holes in a workpiece. Each pilot hole can be aligned with a single-threaded hole of the nutplate, which can be used to attach different airplane parts. At block 120, the process 100 involves deburring the pilot hole. Pilot holes can be deburred to ensure proper installation, finish, and attachment. At block 130, the process 100 involves painting an inner wall of the pilot hole. Inner walls of pilot holes can be painted to add insulation between the inner wall of the pilot hole and a bolt, preventing corrosion and extending a lifetime of an attachment. At block 140, the process 100 involves drilling a nutplate hole. Two nutplate installation holes can be drilled, one on each side of the pilot hole. The installation holes can be aligned with unthreaded holes of the nutplate. At block 150, the process 100 involves riveting a nutplate. The nutplate installation holes can be used to attach the nutplate to the workpiece through riveting.

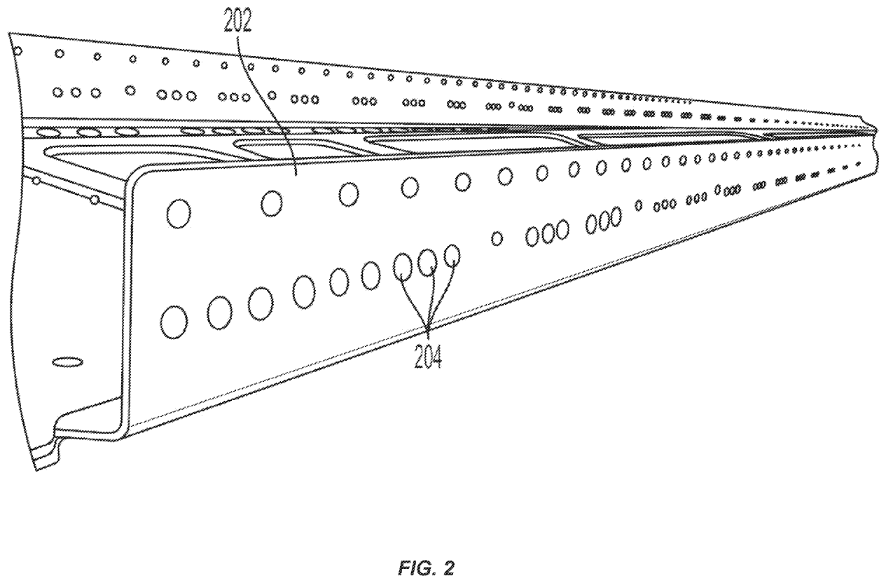

End-effectors for Cobot systems can be designed to perform any task described in FIG. 1 as well as other post-processing machining tasks including hole tapping, reaming, boring, honing, counterboring, countersinking, and trepanning. Hole tapping can create internal screw threads, reaming can improve diameter accuracy and surface finish, boring can enlarge or finish a hole to a specific diameter, honing can improve surface finish, counterboring can enlarge a top of a hole, countersinking can create a conical shape on the top of the hole, and trepanning can remove a circular section from a workpiece to create an oversized hole. In a particular example, a single Cobot platform can include at least two changeable end-effectors, each end-effector designed to automate one of the two tasks described in the two early middle blocks of FIG. 1, i.e., deburring the pilot holes 120 and painting the inner wall of the pilot holes 130. The single Cobot platform can address multiple challenges such as multi-functionality, large aerostructure workpieces, and high precision requirements. As an example of a large workpiece, FIG. 2 is an image of a perspective view of a workpiece 202 with holes 204 for machining tasks according to some aspects of the present disclosure. FIG. 2 shows an aerostructure that can span up to 10 meters. The single Cobot platform can perform multiple tasks using one autonomous Cobot system capable of tool changing to complete any of the machining tasks.

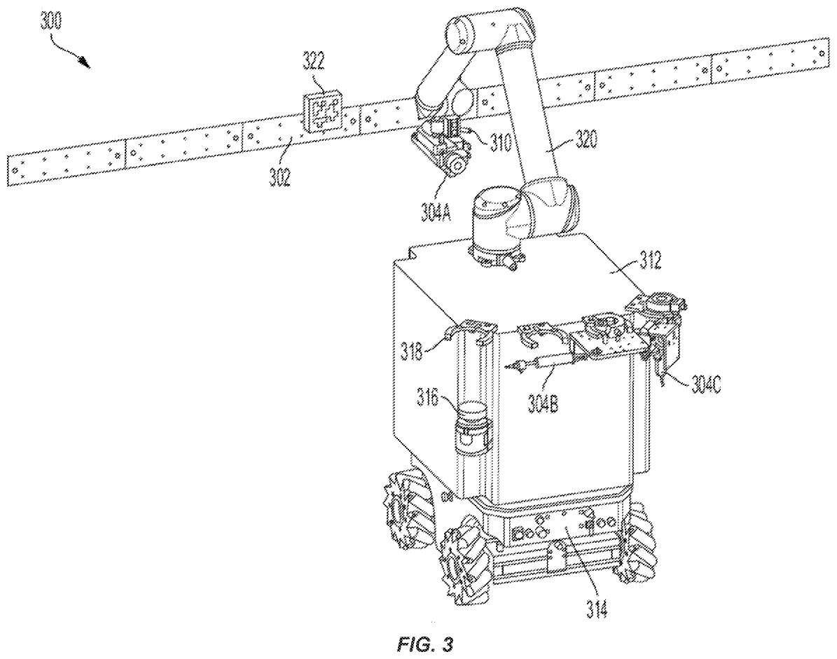

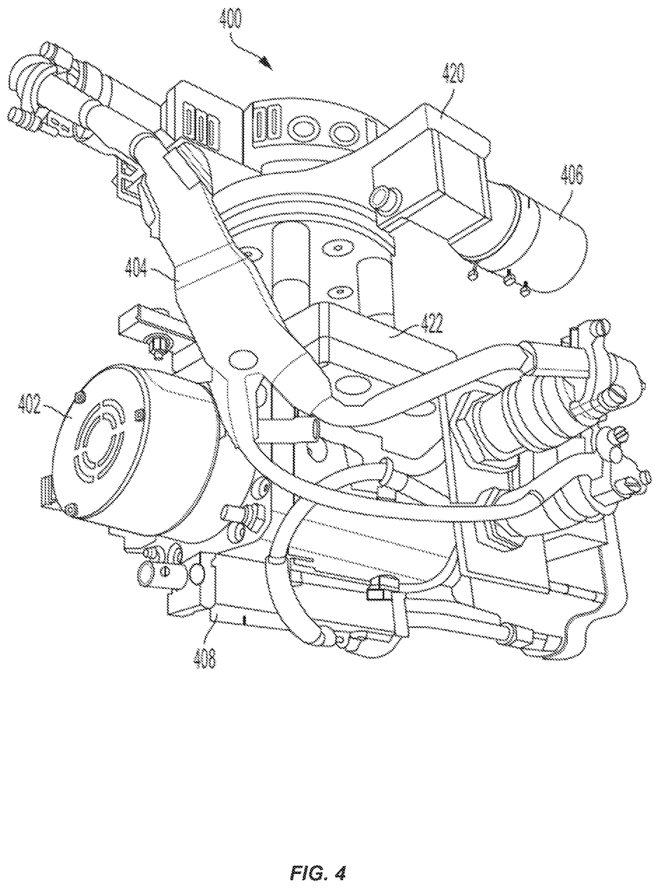

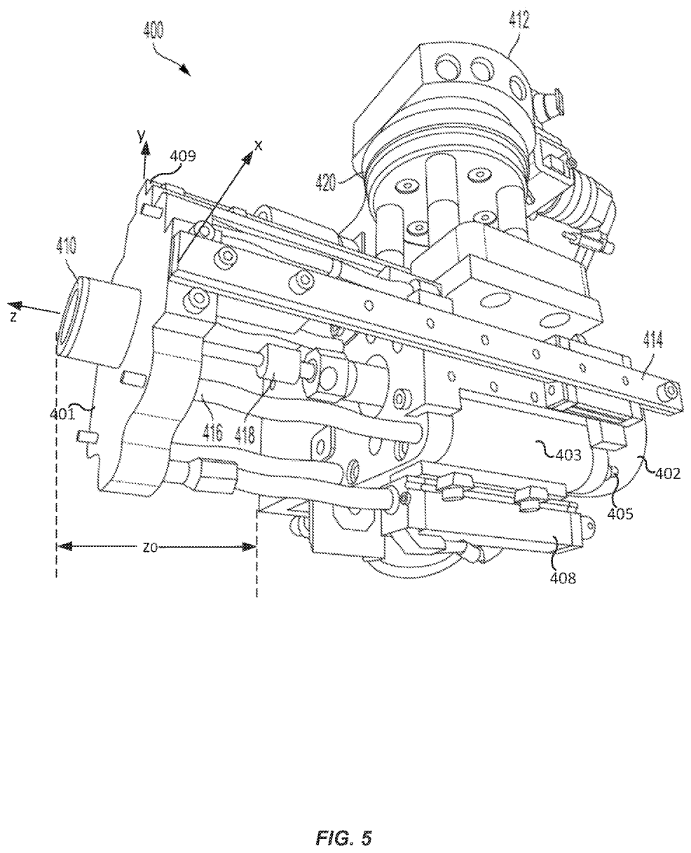

FIG. 3 is a schematic of a perspective view of a multi-functional cobot system environment 300 according to some aspects of the present disclosure. FIG. 3 depicts various components of a vision-based robotic system that can localize and position the multi-functional Cobot system, control a Cobot manipulator 320, and precisely align machining end-effectors to perform tasks. The multi-functional Cobot system can include a mobile robotic platform 314, a Cobot manipulator 320, and multiple end-effectors, e.g., one for each machining task. The mobile robotic platform 314 can be a modified version of a Neobotix MP-500 mobile robotic platform. The Cobot manipulator 320 can be a UR10 manipulator. One end-effector 304A can be attached to the Cobot manipulator 320 by use of a flange of the Cobot manipulator 320 (more easily seen in FIG. 4 or FIG. 5) of the Cobot system while remaining end-effectors (e.g., 304B, 304C) can each be attached to one of a group of tool holders 318 at a back of the mobile robotic platform 314. While FIG. 3 depicts four tool holders 318, only one is labeled for simplicity. The Cobot system environment can include any number of tool holders 318, including one tool holder. The end-effectors in the Cobot system can automatically be exchanged and attached to the manipulator using a tool changer 310. The tool changer 310 can be an ATI QC-21 tool changer. For visual control purposes, the flange of the Cobot system can feature an eye-in-hand camera (more easily seen in FIG. 4). For example, the eye-in-hand camera can be an IDS UI30 camera with a 1920×1080 resolution. As for autonomous mobility functions, two Lidars 316 can be used to simultaneously map an environment and localize the Cobot system. Only one LiDAR is depicted in FIG. 3, as the other LiDAR is on the opposite corner of a robot main body 312 and hidden by the robot main body 312.

The Cobot system can autonomously navigate to a position near a workpiece 302 using the Lidars 316 and a set of four holonomic motorized wheels. The Cobot system can use a fiducial marker 322 on the workpiece 302 to navigate to the position. Once in a predetermined location, the Cobot manipulator 320 can pick one of the multiple tools. The multiple tools can include at least a deburring end-effector 304A and a painting tool 304B, for example. The Cobot system can perform vision-based control to align the end-effector with holes in the workpiece 302 and perform a corresponding machining task on the workpiece 302. Once a machining process is completed on all holes in a vicinity, the Cobot system can either pick up another end-effector to perform another machining task on the holes or the Cobot system can navigate to a different part of the workpiece 302 and re-perform the machining task.

A relatively low stiffness and high compliance of Cobots can impose challenges on repeatability and precision of automated machining tasks. Intelligent end-effectors can be designed to overcome the challenges and stabilize the Cobot while performing various machining processes. Each of the next two sections of this disclosure will describe one of two of the machining processes including deburring and inner-hole painting.

### Design of an Intelligent Machining End-Effector

FIG. 4 is an image of a perspective view of a machining end effector 400 for a Cobot system according to some aspects of the present disclosure. FIG. 5 is an additional image of a perspective view of the machining end effector 400 for the Cobot system according to some aspects of the present disclosure. A machining process in aerospace manufacturing can present multiple functional and precision challenges. For instance, in many airplane structures, both sides of a workpiece may be deburred. An end-effector designed for deburring can be equipped with linear actuation mechanisms. Adding an additional actuation mechanism can increase production costs and weight. The deburring process can be performed within strict specifications of alignment. To meet these strict specifications, traditional machining end-effectors can be equipped with specialized sensors to measure and control alignment, which can increase cost and complexity of design. The intelligent machining end-effector 400 can be used for critical robotic machining applications with high precision and repeatability. The intelligent machining end-effector 400 does not include a linear actuation mechanism. Additionally, the intelligent machining end-effector 400 does not include sensors for normality measurements.

The machining end-effector 400 can include a main part 403, a subpart 401, a spindle motor 402, a main housing structure 422, industrial connectors and harnesses 404, a detection camera 406 (or eye-in-hand camera), a Cobot flange 420, a displacement sensor, such as a linear potentiometer 408, an anti-slipping rubber pad 410, a tool changer 412, x-axis linear slider 414, a y-axis linear slider 409, a mechanical stopper 405 compression springs 416, and a machining bit 418. The linear potentiometer 408 can measure a depth of the machining bit 418 during a machining operation and adjust a feeding speed for fast and accurate operation. The anti-slipping rubber pad 410 can eliminate any slipping during the machining operation and can keep a coating layer of a workpiece from scratching due to metal-metal contact. The compression springs 416 can return a pressing foot to an original position and the x axis linear slider 414 and y axis linear slider 409 can provide accurate motion guidance.

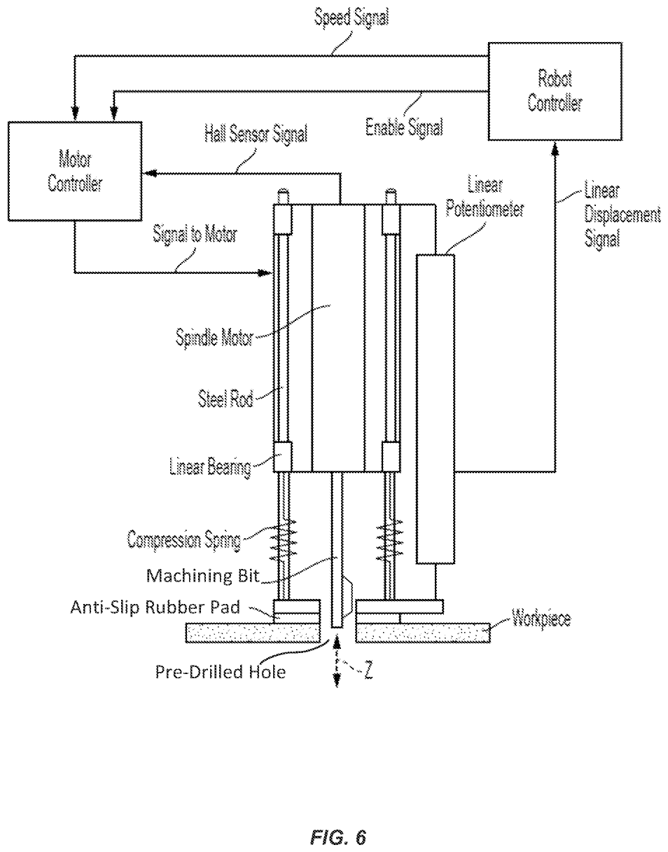

FIG. 6 is an electro-mechanical schematic of a machining end effector for a Cobot system according to some aspects of the present disclosure. The intelligent machining end-effector can include: a 400 W brushless spindle motor, a Daedalus WS55-220 motor driver (depicted as a motor controller in FIG. 6), a machining bit, a LPPS-SL-050 linear potentiometer, and a linear guiding mechanism that can include four compression spring-loaded rods, linear bearings, linear sliders (depicted as steel rods in FIG. 6), and a contact plate padded by anti-slip rubber material. In some examples, the contact plate can be a flat vacuum suction cup with anti-slip treatment in place of the anti-slip rubber material. The main housing structure of the end-effector can be directly installed on a slave part of a Cobot tool changer for fast engagement/disengagement. The linear potentiometer, which can be spring-loaded and include a stroke of 50 mm, can be used to monitor a linear displacement of the machining bit along a machining axis (denoted as “Z” in FIG. 6) within a pre-drilled hole. The Cobot can use measurements from the linear potentiometer to precisely machine both sides of the workpiece by regulating a depth of the machining bit relative to a hole.

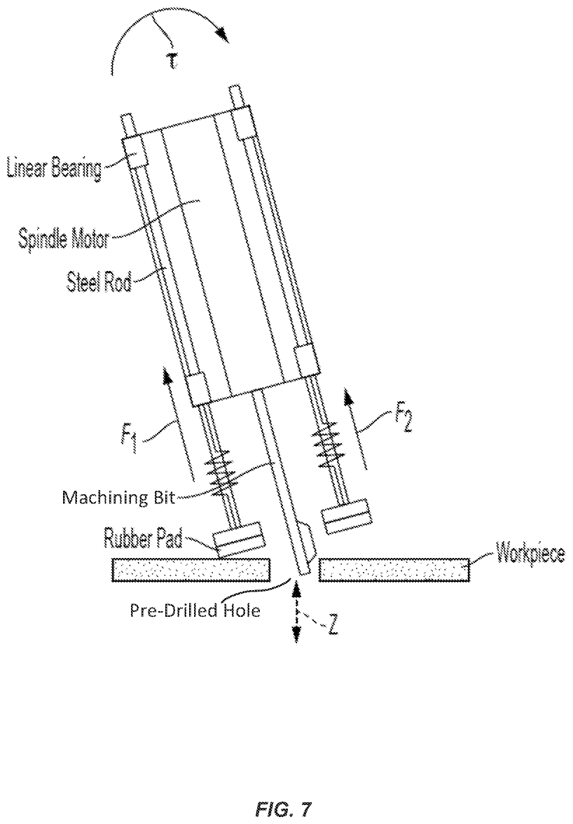

FIG. 7 is a schematic of passive self-alignment features of a machining end effector for a Cobot system according to some aspects of the present disclosure. To precisely align the machining bit to a normal axis of the workpiece, the intelligent machining end-effector can feature the four spring-loaded rods that can connect a pressure foot to the main housing of the machining end-effector. A reaction torque can be generated, using a compliance of the Cobot, to passively align the machining end-effector. The reaction torque can be generated by the spring-loaded rods. The reaction torque can act against the workpiece in a way that can guarantee automatic alignment between the contact plate and the workpiece by utilizing the compliance of the Cobot. For example, when the contact plate initially comes into contact with the workpiece with a misalignment error (i.e., a nonzero angle exists between a normal of the contact plate and a normal of the workpiece), an unbalanced force distribution on the machining end-effector during a machining bit advancing stage will drive the machining end-effector to perfectly jig with the workpiece and remove the misalignment error. As an illustrative example shown in FIG. 7, initial non-normal alignment of the end effector can cause one spring-loaded rod to contact the workpiece and be subject to a greater force F1 from its spring than a force F2 that may be imparted by a spring of another of the rods that may be out of contact or in a less deflected state due to the non-normal alignment. The differences in magnitude of F1 and F2 can impart the reaction torque and can cause rotation of the end effector toward normal alignment. In view of the compliance of the Cobot, the Cobot may continue to yield while the end effector continues to rotate toward normal alignment. On reaching normal alignment, F1 and F2 may be substantially equal, resulting in a cessation of the reaction torque and accordingly a cessation of yielding by the Cobot such that the Cobot can resultingly hold the end effector in the normal-alignment. A design of the machining end-effector can restrict planar movement during the machining process relative to the workpiece using the two linear sliders that connect the end-effector main housing with the dynamic pressure foot/contact plate. The linear guiding mechanism can facilitate motion along the deburr axis but can prevent in-plane positional deviations. The pressure foot can feature a rubber pad that minimizes slippage and can prevent metal-metal contact that can cause corrosion. The rubber pad can also damp vibrations caused by the deburring process, thereby further stabilizing interaction between tool and workpiece.

An automation flow for a machining process such as deburring can proceed as follows. After locating a workpiece using fiducial markers, holes can be detected using a visual detection algorithm. After detecting the holes, the Cobot can align the machining end-effector with a pre-drilled target hole and can advance the machining bit to a predefined depth inside the target hole. During insertion, the Cobot can simultaneously monitor a signal of the linear potentiometer and a force feedback signal detected by joints of the Cobot system to ensure error-free insertion. For example, if the Cobot system starts advancing the machining bit inside the target hole and an unusual increase in force feedback is detected by joints of the Cobot, the Cobot system can identify an error and terminate insertion of the machining bit. When an error is detected, the Cobot can revert back to the detection stage and re-initialize the insertion process. After successful bit insertion inside the target hole, the Cobot can send a signal to the motor controller to start rotating with a predefined speed. The rotation speed can be monitored by a rotational speed sensor, such as a hall sensor, embedded in the motor. Simultaneously, the Cobot can advance and retreat the machining end-effector to achieve deburring profiles on both sides of the workpiece. After deburring the target hole, the Cobot can continue with the procedure for the rest of the holes in the workpiece.

### Design of an Intelligent Painting End-Effector

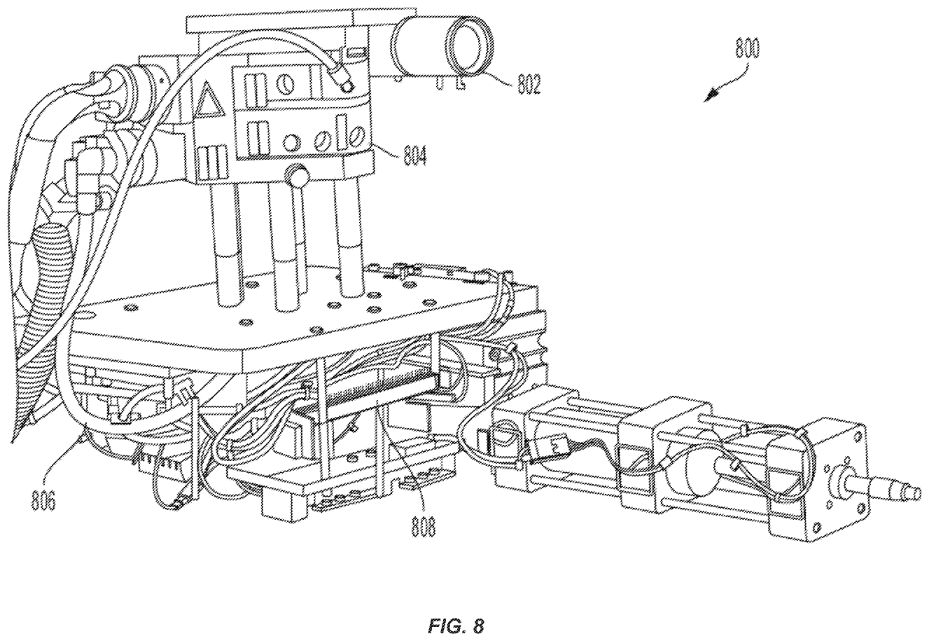

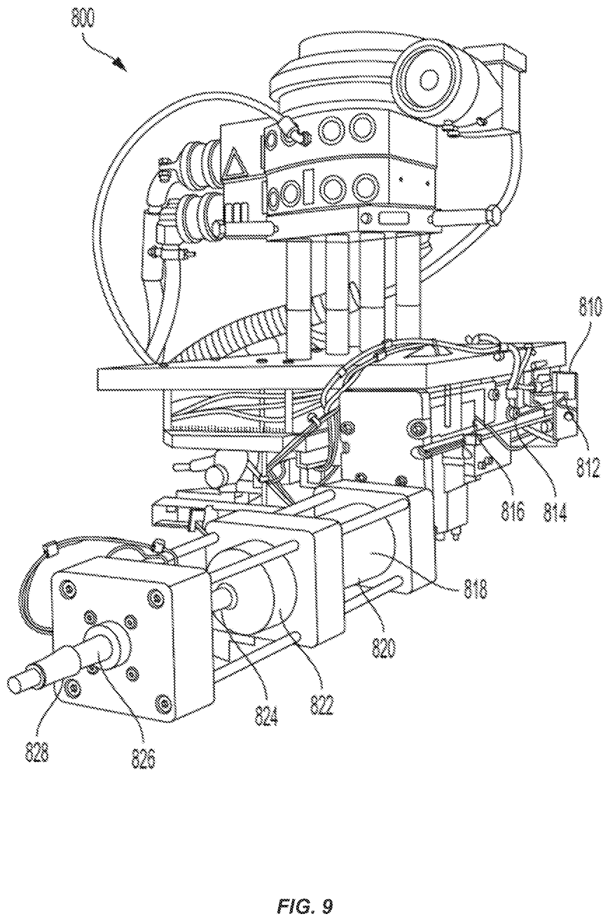

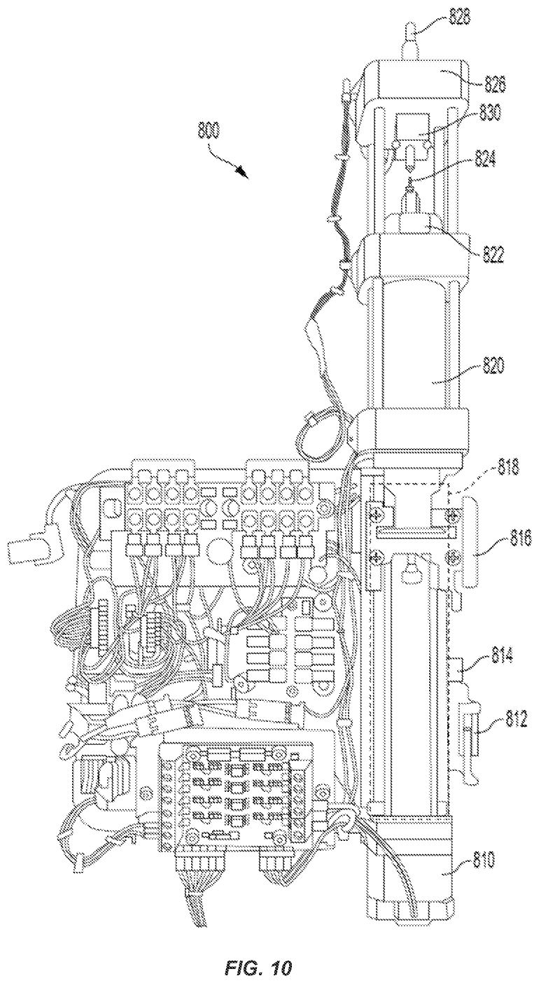

An automation of painting processes in manufacturing can present numerous challenges to ensure uniform coating and precise layer thickness. Painting of inner walls of machined holes can be critical for coating and insulation purposes in the aerospace industry. FIG. 8 is an image of a perspective view of a painting end effector 800 for a Cobot system according to some aspects of the present disclosure. FIG. 9 is an additional image of a perspective view of the painting end effector 800 for a Cobot system according to some aspects of the present disclosure. The intelligent painting end-effector can include a lead screw mechanism 814, a stepper motor 810, a hollow shaft stepper motor (which can be more easily observed in FIG. 10), a syringe reservoir/barrel 820, a syringe plunger 818, a long syringe needle 824, a disposable cylindrical sponge head 828, stepper motors' controllers 806, an Arduino Due controller 808, a camera 802, a tool changer 804, an upper level limit switch 812, a lower level limit switch 816, coating solution 822, and a hollow shaft 826.

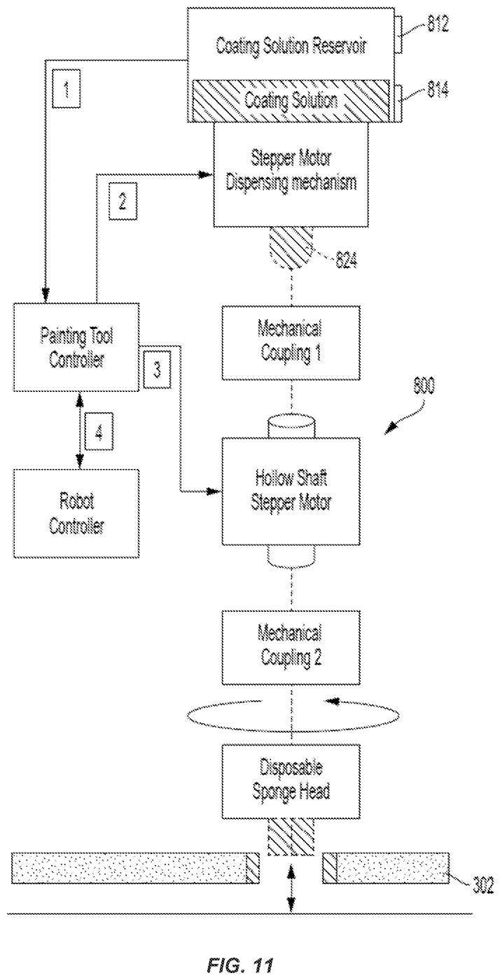

FIG. 10 is an image of a side view of a painting end effector 800 for a Cobot system for highlighting electro-mechanical components according to some aspects of the present disclosure. FIG. 11 is an electro-mechanical schematic of the painting end effector 800 for a Cobot system according to some aspects of the present disclosure. The syringe reservoir/barrel 820 can store a coating solution 822. The syringe plunger 818 can expel/dispense the coating solution 822. The long syringe needle 824 can deliver the coating solution 822 to a head of the disposable cylindrical sponge 828 through the hollow shaft stepper motor 830. The long syringe needle 824 can include dimensions such as a length of 80 mm and a diameter of 1 mm. Limit switches can be mounted to monitor upper and lower levels of the syringe reservoir/barrel 820 during operation. The stepper motor 810 can be attached to and used to drive the lead screw mechanism 814. A model 17HDC4069Z-352N15 is one example of the stepper motor 810. The lead screw mechanism 814 can convert rotational motion into linear motion with a very high resolution of 0.05 mm and can drive the syringe plunger 818 to control dispensing action. A high-resolution motion of the stepper motor 810 can be achieved through micro-stepping control implemented using a DM320T stepper motor driver. A hollow shaft stepper motor 830 of model 8HY0001-7SK can be used. A stationary part of the hollow shaft stepper motor 830 can be connected to the end-effector's housing while a dynamic part can be connected with the disposable sponge head 828. The hollow shaft 826 can allow the long syringe needle 824 to reach and carry the coating solution 822 to the disposable sponge head 828. The hollow shaft stepper motor 830 can ensure uniform/homogeneous coating of inner surfaces of primary holes by continuously rotating the disposable sponge head 828 during dispensing action. The Arduino Due controller 808 can serve as an independent controller and can communicate with a main controller of the Cobot to trigger both stepper motors simultaneously and monitor coating solution level and a location of the syringe plunger's end via the upper-level limit switch 812 and the lower-level limit switch 816. A first mechanical coupling can be established between a dispensing mechanism and the stationary side of the hollow shaft stepper motor 830. A second mechanical coupling can be established between the rotating sponge head 828 and the dynamic part of the hollow shaft stepper motor 830.

An automation flow for painting can proceed as follows. After locating the workpiece (such as by using fiducial markers or other suitable techniques), detecting pilot holes, and finishing the deburring process, the Cobot can disengage the deburring end-effector and engage the painting end-effector through programmed motion planning. The Cobot can know exact mounting locations for both end-effectors. The Cobot can align the painting end-effector with a target pilot hole for coating. The Cobot can monitor force feedback to ensure that the disposable sponge head is inside the target pilot hole for coating. For example, when a rigid end of the painting end-effector touches the workpiece, force readings will increase indicating that the disposable sponge head has reached the target pilot hole for coating. The Cobot can retract the painting end-effector two millimeters to avoid direct contact with the workpiece except for the disposable sponge head. The Cobot can send a trigger signal to the Arduino controller to start a painting process. After receiving the trigger signal, the Arduino can send a signal to the stepper motors controllers to rotate and start a dispensing action. A programmable precise amount of coating solution can be injected inside the disposable sponge head. The precise amount of coating solution can be calculated based on measurements of the target pilot hole and a desired layer thickness of the coating solution. After a first hole is coated, the Arduino controller can send an acknowledgement signal to the controller of the Cobot to proceed to another target hole and perform the painting process to another target hole.

### Vision-Based Cobot Control

Machining tasks within a scope of the Cobot system can involve a peg-in-hole process, where the Cobot system can precisely insert a specific component of an end-effector into a target pilot hole. Examples of the specific component can include the deburring bit of the deburring end-effector or the disposable sponge head of the painting end-effector. A clearance for each of the peg-in-hole processes can be 0.1 mm. Thus, the Cobot can perform the peg-in-hole processes effectively with a maximum positioning error of less than 0.1 mm. Since a Cobot manipulator can be installed on a mobile platform and can operate in a dynamic and unstructured environment where a location of the workpiece can be variable, movements that the Cobot can perform to complete tasks cannot be taught manually. The Cobot may need intelligent perception, planning, and control capabilities to adapt to varied conditions while maintaining a predetermined level of precision. The Cobot can be equipped with an eye-in-hand camera. The Cobot can use the eye-in-hand camera to control motion of a manipulator during each machining process.

### Examples

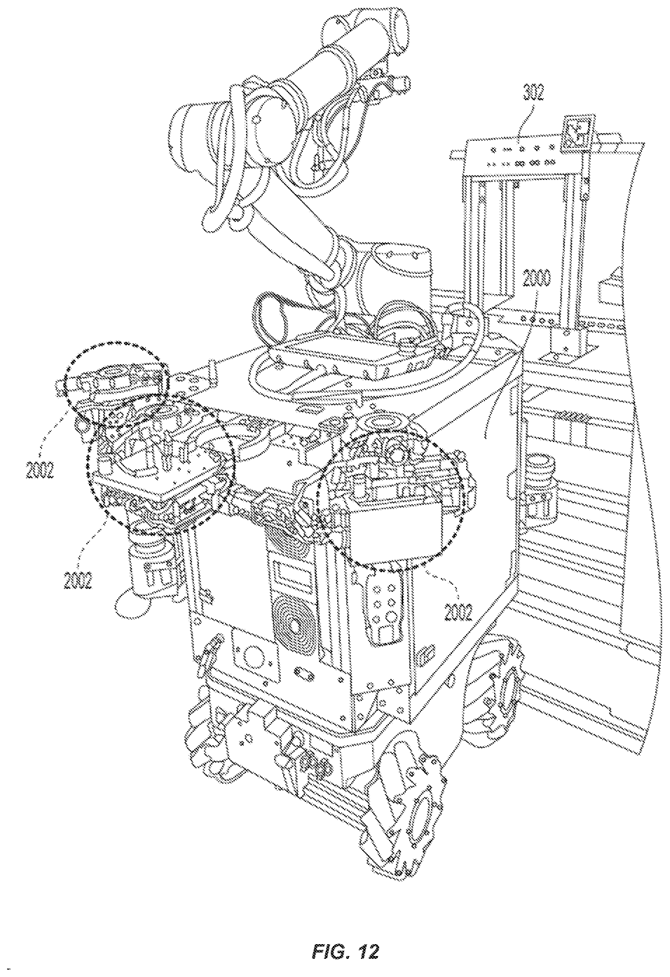

FIG. 12 is an image of a perspective view of a Cobot system 2000 according to some aspects of the present disclosure. The multi-functional Cobot system 2000 shown in FIG. 12 can perform various machining tasks, such as deburring and painting, on a workpiece 302 using end-effectors 2002. Qualitative and quantitative investigations shown in the examples portion of the application are presented in two different sections for each such task the Cobot performs, in addition to an overall multi-tasking performance of the Cobot system 2000.

### Deburring Results

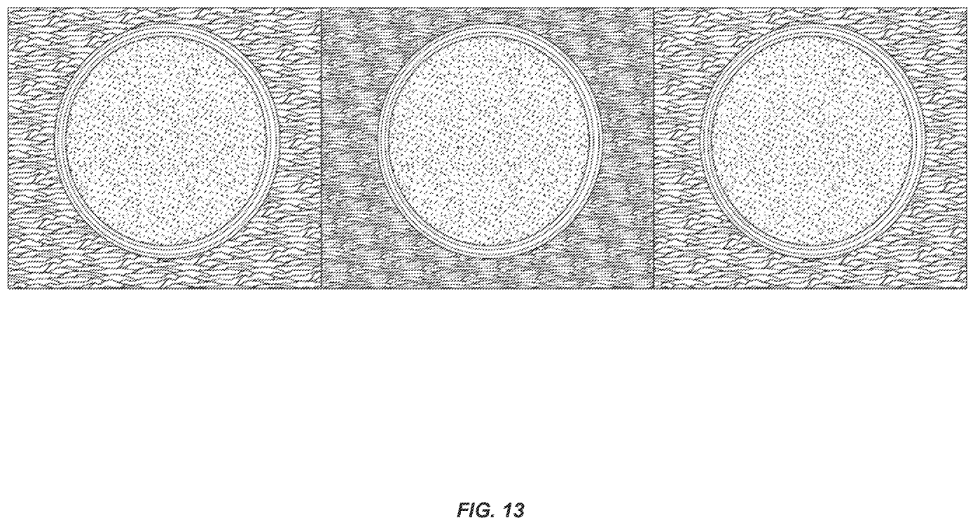

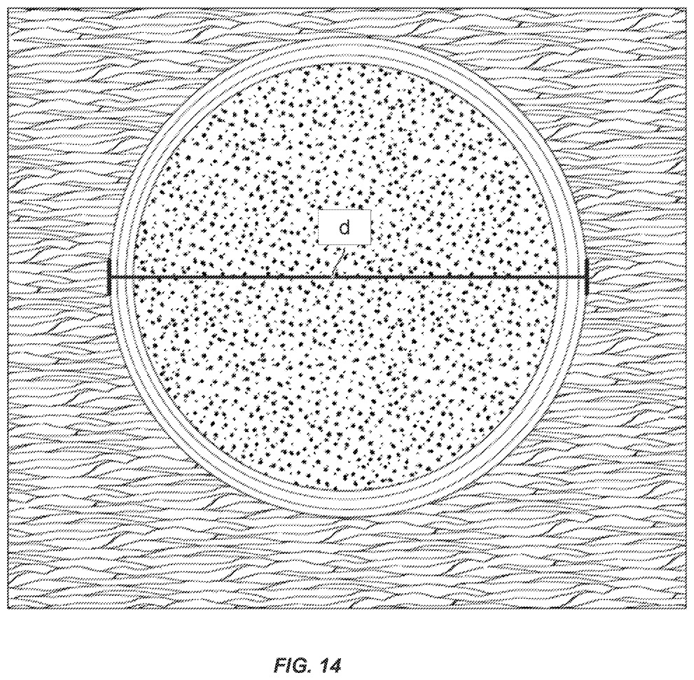

Deburring experiments were conducted on two different types of workpieces with ten holes each. Repeatability of the Cobot system in performing deburring operations was analyzed. FIG. 13 is an image of a front view of three holes deburred by a deburring end effector of a Cobot system according to some aspects of the present disclosure. FIG. 13 shows a close-up view of deburring performance across different holes. The close-up view demonstrates a high repeatability of a deburring end-effector. FIG. 14 is an image of a front view of a hole deburred by a deburring end effector of a Cobot system that highlights a chamfer diameter according to some aspects of the present disclosure. Deburring performance can be quantified in terms of a chamfer diameter. The chamfer diameter d is illustrated in FIG. 14 and was measured using an Olympus BX51 microscope. Table 1 reports the chamfer diameter across multiple holes and workpieces. The table describes the repeatability of the Cobot, with a standard deviation in the chamfer diameter of 0.011 mm. The Cobot system can accurately perform deburring operations with a standard deviation on an order of ten microns. The Cobot system may deburr holes with a standard deviation of less than 0.02 mm, for example.

TABLE 1
Summary of Chamfer diameter data (in mm) for deburred holes across multiple workpieces.

| Work | Hole ID | | | | | | | | | | | | Std |
|---|---|---|---|---|---|---|---|---|---|---|---|---|---|
| piece | 1 | 2 | 3 | 4 | 5 | 6 | 7 | 8 | 9 | 10 | Mean | Max | Dev |
| A | 5.381 | 5.424 | 5.411 | 5.420 | 5.412 | 5.413 | 5.421 | 5.424 | 5.412 | 5.409 | 5.413 | 5.424 | 0.012 |
| B | 5.411 | 5.432 | 5.400 | 5.402 | 5.412 | 5.414 | 5.401 | 5.424 | 5.391 | 5.413 | 5.400 | 5.432 | 0.012 |

| | | | |
|---|---|---|---|
| Aggregate | 5.411 | 5.432 | 0.011 |

### Painting Results

A painting process is performed as follows: after the Cobot locates the workpiece, identifies holes in the workpiece, and finishes deburring, the cobot disengages the deburring end-effector and engages a painting end-effector through a pre-programmed motion. The cobot proceeds to paint an inner wall of all target pilot holes on the workpiece as explained previously.

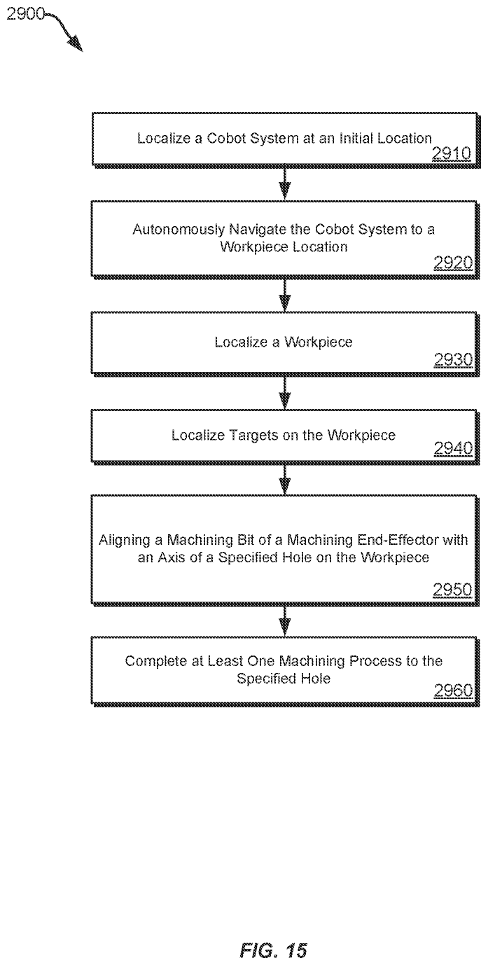

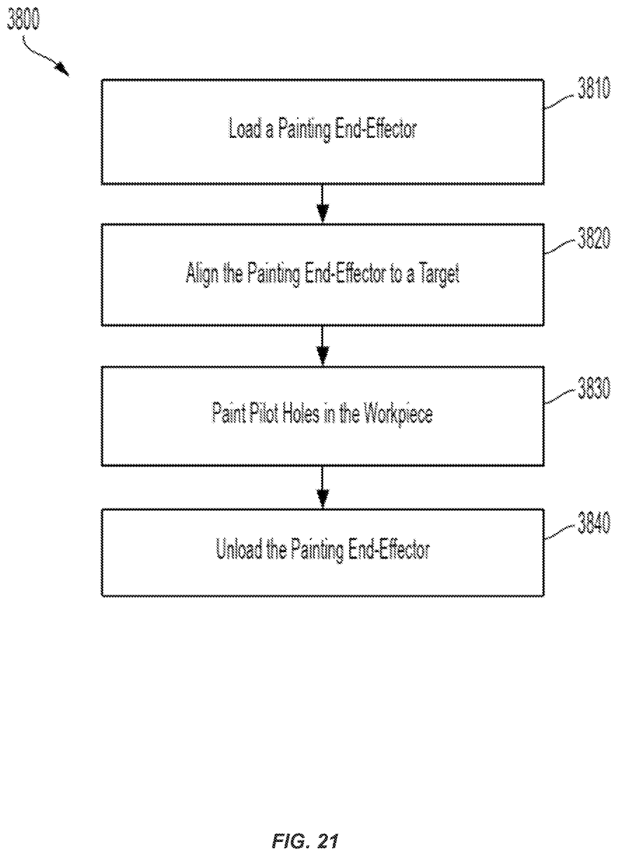

In some examples, a Cobot computing controller associated with the Cobot system can implement the process 2900 shown in FIG. 15 or the process 3800 shown in FIG. 21, Other examples can involve more operations, fewer operations, different operations, or a different order of operations shown in those figures. Note that processes 2900 and 3800 can be performed in any order. The operations of FIG. 15 will now be described below. Some or all of the steps of process 2900 or process 3800 can be performed by a processor associated with the Cobot computing controller.

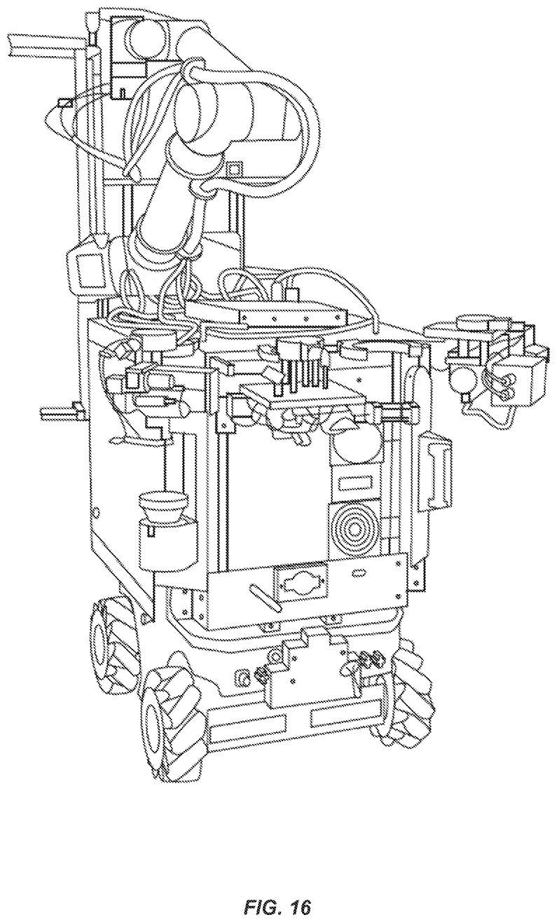

Referring now to FIG. 15, at block 2910, the process 2900 involves localizing a Cobot system at an initial location. Reflective markers can be used to characterize fixed artifacts in a workplace environment. Two sick S300 LiDARs installed on the Cobot system can measure reflectiveness of surfaces in the workplace environment. Non-reflective surfaces can be filtered out from the LiDAR scans. Localization can be performed relative to the fixed artifacts exclusively. FIG. 16 is an image of a Cobot system at an initial location according to some aspects of the present disclosure.

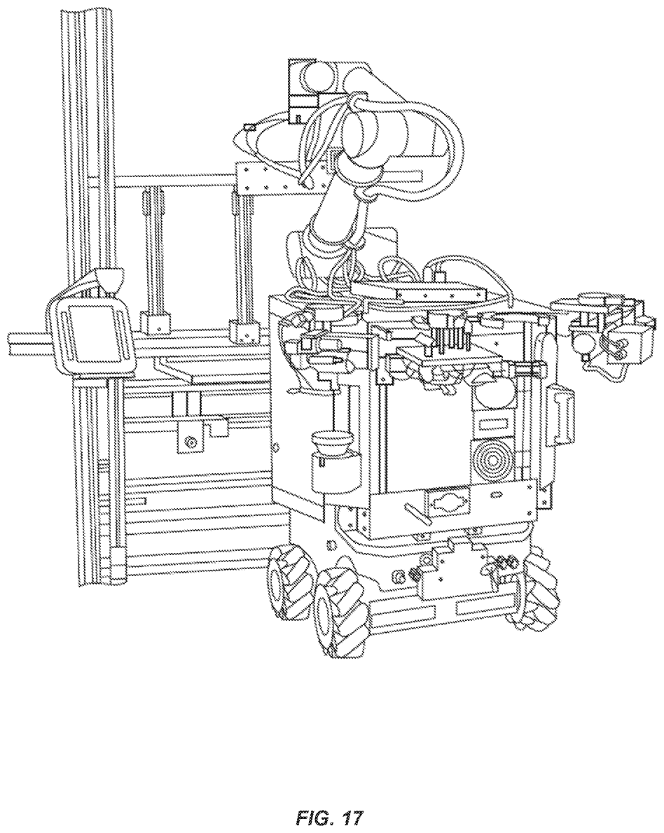

At block 2920, the process 2900 involves autonomously navigating the Cobot System to a workplace location. Once the Cobot is localized, the cobot system can generate a path toward the workpiece while avoiding static and dynamic obstacles. The Cobot system can use global and local planners from an ROS Navigation stack to generate the path. ROS can be an open-source robotics middleware suite. The Cobot system can execute the planned path using holonomic wheels, which can be independently actuated using a brushless DC motor. FIG. 17 is an image of the Cobot system after autonomous navigation to a workpiece location according to some aspects of the present disclosure. The Cobot can navigate to an estimated location of the sample workpiece.

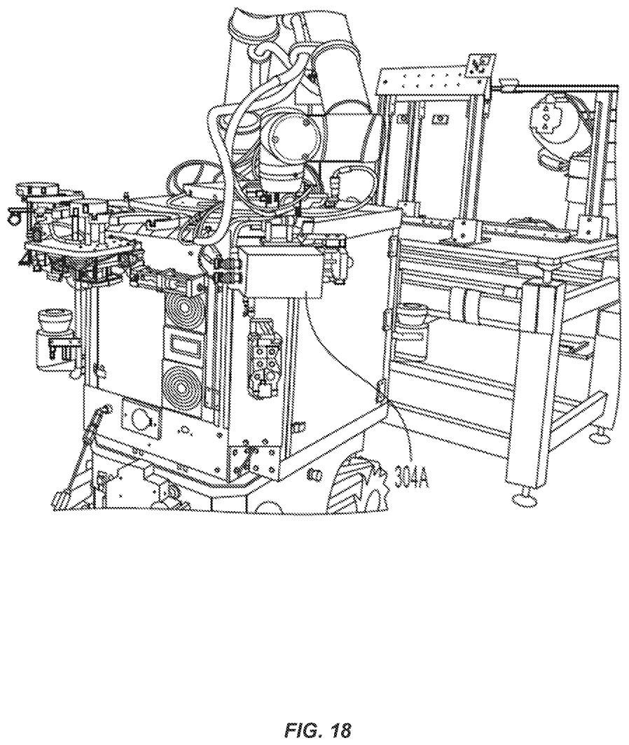

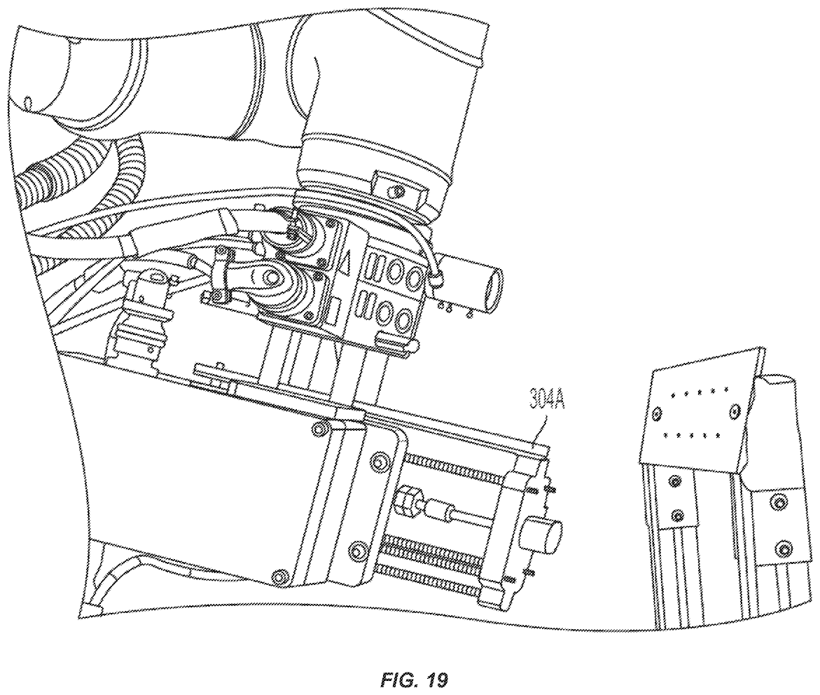

In some examples, the process 2900 can involve loading a deburring end-effector. The Cobot system can select the deburring end-effector from among a group of end-effectors stored in tool holders on a robot main body. The Cobot system can bring a Cobot manipulator near the deburring end-effector and a tool changer can attach the deburring end-effector to a flange of the Cobot manipulator. The Cobot manipulator can return to a position near the workpiece. FIG. 18 is an image of the Cobot system loading a deburring end effector 304A according to some aspects of the present disclosure. FIG. 19 is an image depicting the deburring end effector 304A in an initial pose prior to workpiece localization according to some aspects of the present disclosure.

At block 2930, the process 2900 involves localize the workpiece. The workpiece can include a fiducial marker. A fiducial marker can be an object placed in a field of view of an imaging system that can appear in a produced image. The Cobot system can use the fiducial marker to localize an object, such as the workpiece. The fiducial marker can also be used to set up a camera system, such as an eye-in-hand camera of the Cobot system, in a starting location as the camera system searches for targets for completing a machining process on the workpiece.

At block 2940, the process 2900 involves localizing targets on the workpiece. For example, the targets can be pre-drilled holes such as pilot holes. To locate a target pilot hole, the Cobot system can image a portion of the workpiece. The portion can include the target pilot hole. An algorithm can be used to locate all circles in the image. An algorithm that includes a deviation score and a size score can be used to localize the target pilot hole. A combined score of deviation and size can be used to filter out undesired circle detections and select a most suitable location for the target pilot hole.

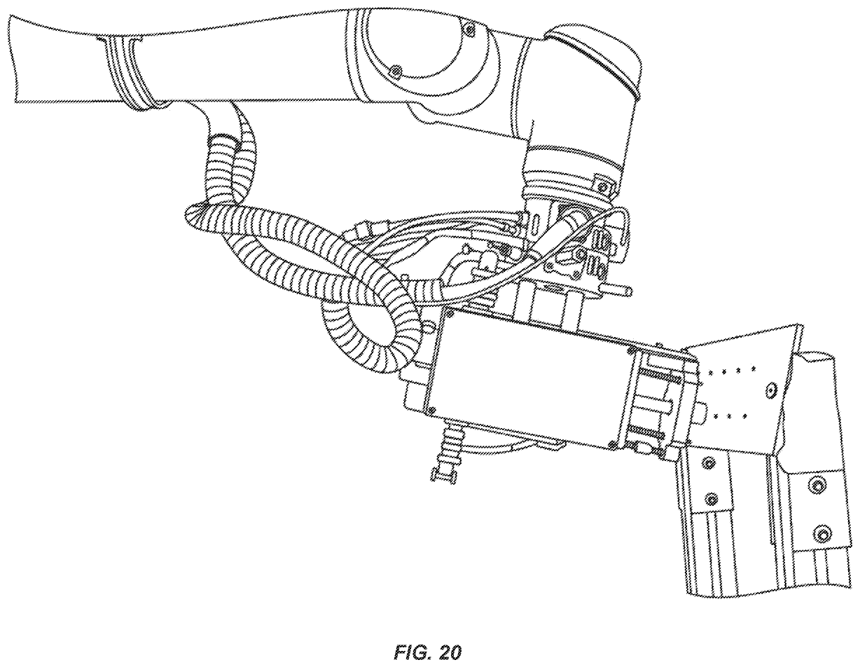

At block 2950, the process 2900 involves aligning a machining bit of a machining end-effector with an axis of a specified hole on the workpiece. The specified hole can be a pilot hole for completing a machining process such as deburring. The Cobot system can perform vision-based control to align the machining end-effector with the axis of the specified hole. Components of the machining end-effector can aid in the alignment. The machining end-effector can include a linear guiding mechanism that includes a set of four spring-loaded rods that can connect a pressure foot to a main housing of the end-effector (e.g., such as described with respect to FIGS. 6 and 7). The linear guiding mechanism can generate a reaction torque that makes use of a compliance of the Cobot to passively align the machining end-effector. For example, when the contact plate initially comes into contact with the workpiece with a misalignment error (i.e., a nonzero angle exists between a normal of the contact plate and a normal of the workpiece), an unbalanced force distribution on the machining end-effector during a machining bit advancing stage will drive the deburring end-effector to perfectly jig with the workpiece and remove the misalignment error. FIG. 20 is an image depicting an alignment of the machining end effector with the specified hole by a manipulator of the Cobot system according to some aspects of the present disclosure.

At block 2960, the process 2900 involves completing at least one machining process to the specified hole on the workpiece. For example, the machining process can be a deburring process. A machining bit of the machining end-effector can be inserted into the specified hole. A displacement sensor (such as linear potentiometer 408 depicted in FIG. 4) of the machining end-effector can be used to monitor a linear displacement of the machining bit along the axis of the specified hole. During the insertion process, the Cobot system can simultaneously monitor a signal from the displacement sensor and a force feedback signal to ensure error-free insertion. Once the machining bit reaches a desired depth in the pilot hole, a controller of the Cobot system can communicate with a spindle motor controller (such as the motor controller depicted in FIG. 6) and rotate the machining bit. Both ends of the specified hole can be deburred using the machining end-effector. After deburring the specified hole, the machining end-effector can be realigned with a different specified hole and the different specified hole can be deburred. Final results of the deburring process are depicted in FIG. 13.

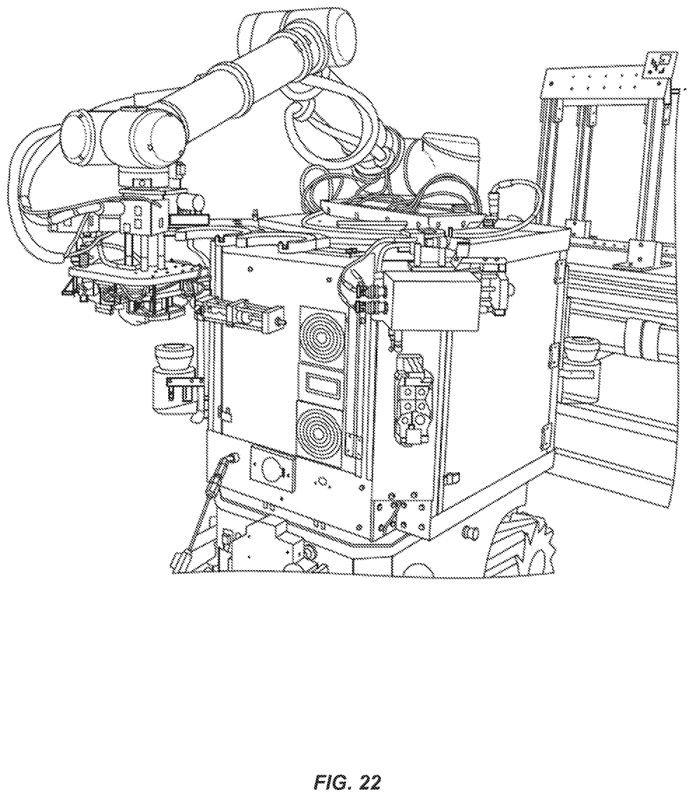

The operations of FIG. 21 will now be described below with reference to the components described above. At block 3810, the process 3800 involves loading a painting end-effector. The Cobot system can select the painting end-effector from among a group of end-effectors stored in tool holders on a robot main body. The Cobot system can bring a Cobot manipulator near the painting end-effector and a tool changer can attach the painting end-effector to a flange of the Cobot manipulator. The Cobot manipulator can return to a position near the workpiece. FIG. 22 is an image of the Cobot system as the Cobot system loads the painting end-effector according to some aspects of the present disclosure.

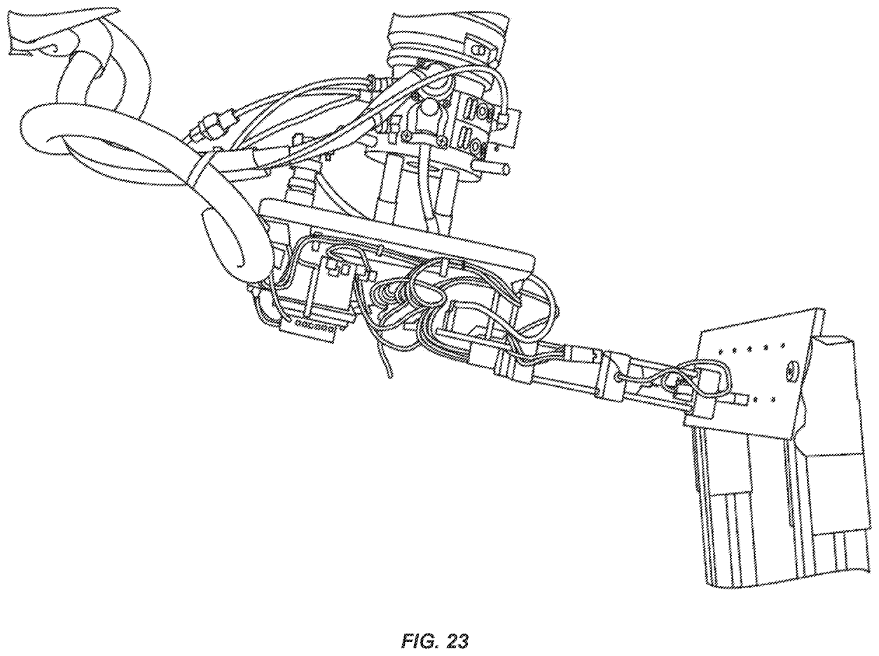

At block 3820, the process 3800 involves aligning the painting end-effector to a target. The target can be a pilot hole for deburring. The Cobot system can perform vision-based control to align the painting end-effector with a target pilot hole. The Cobot system can monitor a force feedback signal from Cobot joints to ensure that a sponge head of the painting end-effector is inside the pilot hole. When a rigid end of the painting end-effector touches the workpiece, force readings can increase to indicate that the sponge head has reached the pilot hole. The Cobot system can retract the painting end-effector two millimeters to avoid direct contact with the workpiece except for the sponge head. FIG. 23 is an image depicting an alignment of the painting end effector with a target hole by the manipulator of the Cobot system according to some aspects of the present disclosure.

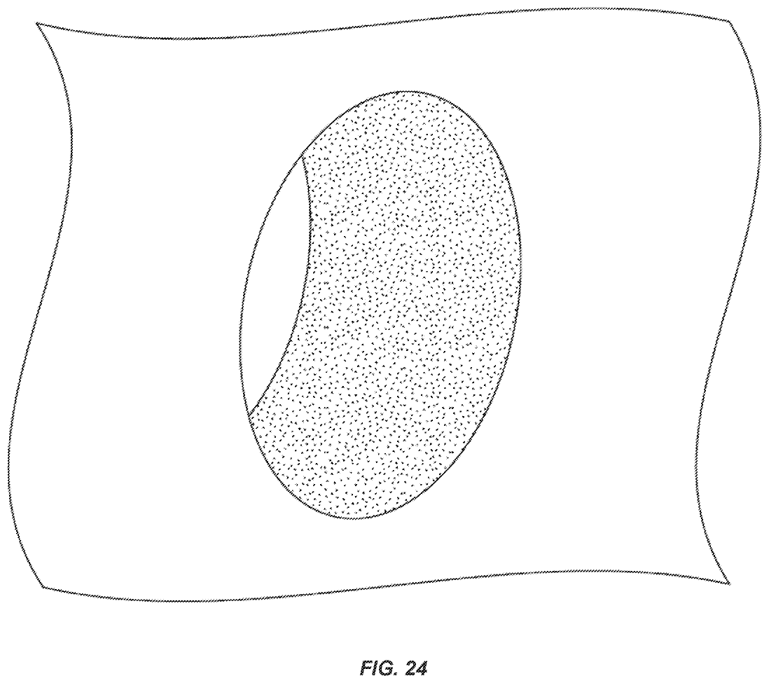

At block 3830, the process 3800 involves painting the pilot holes in the workpiece. After retracting the painting end-effector, the Cobot system can signal an Arduino controller to start the painting process. The Arduino controller can send a signal to a stepper motor controller of the painting end-effector to rotate the sponge head and start dispensing of a coating solution. The dispensing mechanism can be controlled to precisely inject a programmable amount of coating solution inside the disposable sponge head. The programmable amount can be calculated based on measurements of the pilot hole and a predetermined thickness of the coating solution. After a pilot hole is coated, the Arduino controller can send an acknowledgement signal to the Cobot system to proceed to another hole and repeat the painting process. The painting process can continue until all pilot holes in the workpiece have been painted. FIG. 24 is an image of an inside of a hole painted by the painting end-effector of the Cobot system according to some aspects of the present disclosure.

At block 3840, the process 3800 involves unloading the painting end-effector. After all pilot holes of a workpiece have been painted, the Cobot manipulator can be moved near a tool holder on a robot main body of the Cobot system. The tool changer can detach the painting end-effector from the Cobot manipulator.

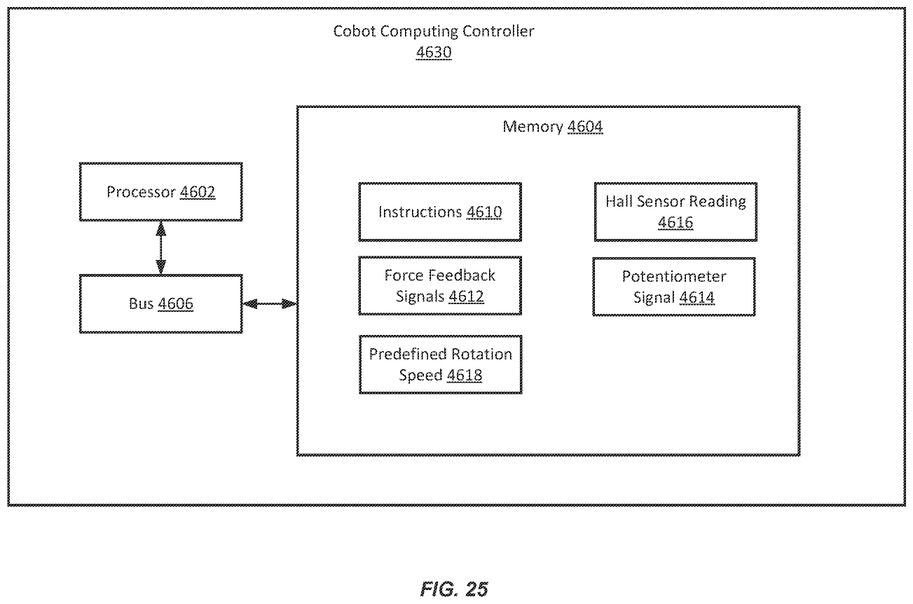

FIG. 25 is a block diagram of an example Cobot computing controller 4630 for controlling a Cobot system as the Cobot system completes multiple manufacturing tasks according to some aspects of the present disclosure. As shown, the Cobot computing controller 4630 includes the processor 4602 communicatively coupled to the memory 4604. The processor 4602 can include one processing device or multiple processing devices. Non-limiting examples of the processor 4602 include a Field-Programmable Gate Array (FPGA), an application specific integrated circuit (ASIC), a microprocessor, or any combination of these. The processor 4602 can execute instructions 4610 stored in the memory 4604 to perform operations. In some examples, the instructions 4610 can include processor-specific instructions generated by a compiler or an interpreter from code written in any suitable computer-programming language, such as C, C++, C#, Python, or Java.

The memory 4604 can include one memory device or multiple memory devices. The memory 4604 can be non-volatile and may include any type of memory device that retains stored information when powered off. Non-limiting examples of the memory 4604 include electrically erasable and programmable read-only memory (EEPROM), flash memory, or any other type of non-volatile memory. At least some of the memory 4604 can include a non-transitory computer-readable medium from which the processor 4602 can read instructions 4610. The non-transitory computer-readable medium can include electronic, optical, magnetic, or other storage devices capable of providing the processor 4602 with the instructions 4610 or other program code. Non-limiting examples of the non-transitory computer-readable medium include magnetic disk(s), memory chip(s), RAM, an ASIC, or any other medium from which a computer processor can read instructions 4610.

The memory 4604 can further include contact force feedback signals 4612, a rotational speed sensor reading, such as a hall sensor reading 4616, a predefined rotation speed 4618, and a potentiometer signal 4614. The Cobot system can estimate contact forces based on torques measured at joints and monitor the advancement of the machining bit along the axis of the specified hole using the contact force. The Cobot computing controller 4630 can use the force feedback signals 4612 from joints of the Cobot system and the potentiometer signal to monitor a displacement of a deburring bit of a deburring end-effector while the deburring bit is being inserted, advanced, or retracted in a workpiece. The force feedback signals 4612 or the potentiometer signal 4614 can indicate an error or deviation in the displacement of the deburring bit. The Cobot computing controller 4630 can respond to the error or deviation by, for example, terminating an insertion of the deburring bit. In some examples, the Cobot system can detect faults or abnormalities based on a comparison of estimated contact forces to readings from the displacement sensor (e.g., the linear potentiometer). A motor of the deburring end-effector can cause the deburring bit to rotate with a rotation speed set to the predetermined rotation speed 4618. The Cobot computing controller 4630 can monitor the rotation speed of the deburring bit using the hall sensor reading 4616. The Cobot computing controller 4630 can compare the hall sensor reading 4616 to the predetermined rotation speed 4618. If the hall sensor reading 4616 and the predetermined rotation speed 4618 do not match, the Cobot computing controller 4630 can cause the motor of the deburring end-effector to make adjustments.

The Cobot system can use vision-based control with multiple end-effectors in manufacturing applications, such as aerospace machining applications. The Cobot system can accurately position the Cobot relative to a target workpiece. In addition, the Cobot system can select an end-effector to perform a specific machining task, align the end-effector with a target on the workpiece, and perform the specific machining task with a high precision. The Cobot system can include a camera, a robotic manipulator, and customized end-effectors.

Examples of the Cobot system show that the Cobot system can precisely position end-effectors while performing tasks such as drilling, deburring, and painting. Moreover, the Cobot system can perform the tasks with high accuracy, precision, and repeatability as required by aerospace industrial standards compared to conventional systems. The examples demonstrate a potential of a multi-end effector Cobot system in improving efficiency and reliability of manufacturing processes.

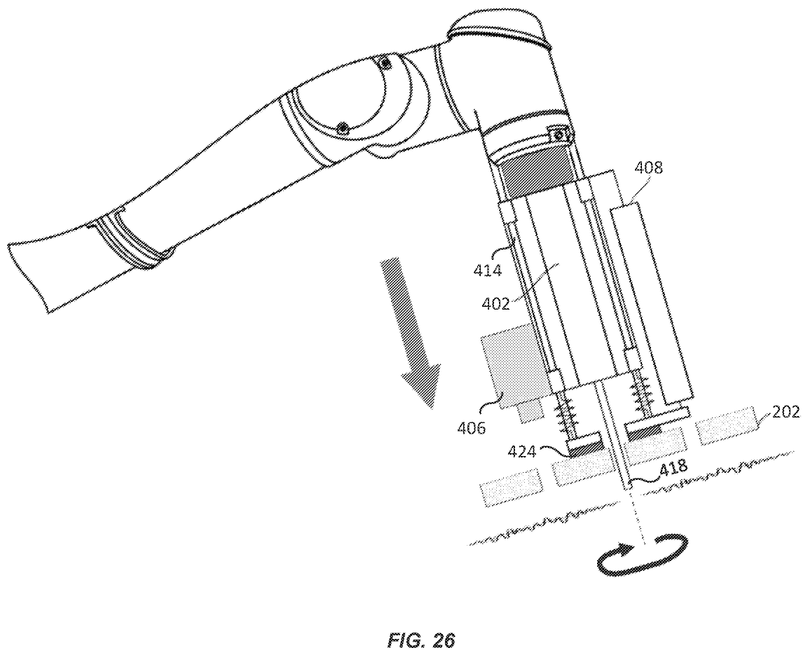

FIG. 26 is an image of a machining end-effector applying a machining process to a pre-drilled hole of a workpiece 202 according to some aspects of the present disclosure. The machining end-effector can include a main part and a detachable subpart. The main part can include a spindle motor 402, a camera 406, and a machining bit 418. The subpart can include linear slides 414, a linear potentiometer 408, and an anti-slip rubber pad 424 that can contact the workpiece 202 and reduce vibrations during the machining process. The spindle motor 402 can rotate the machining bit 418 to complete machining processes such as deburring at various depths within the pre-drilled hole. The linear potentiometer 408 can monitor the depth positions of the machining bit 418 and monitor a separation distance between the main part and the subpart during machining processes.

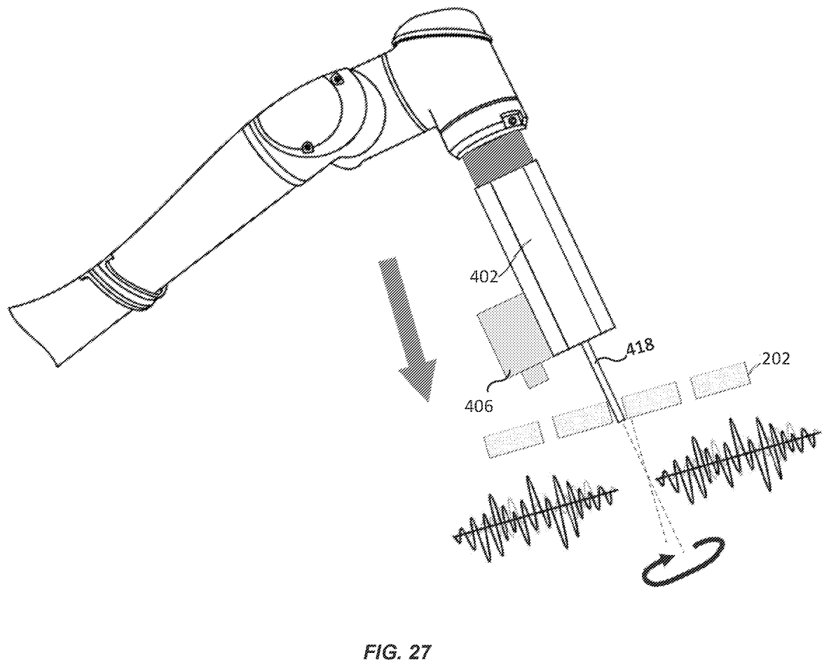

FIG. 27 is an image of a main part of a machining end-effector applying a machining process to a pre-drilled hole of a workpiece 202 according to some aspects of the present disclosure. The main part can act independently of a detachable subpart of the machining end-effector. The main part can include a spindle motor 402, a camera 406, and a machining bit 418. The spindle motor 402 can rotate the machining bit 418 to complete machining processes such as deburring at various depths within the pre-drilled hole. The main part can act independently to complete machining processes that can be less precise since more vibrations may occur without the detachable subpart.

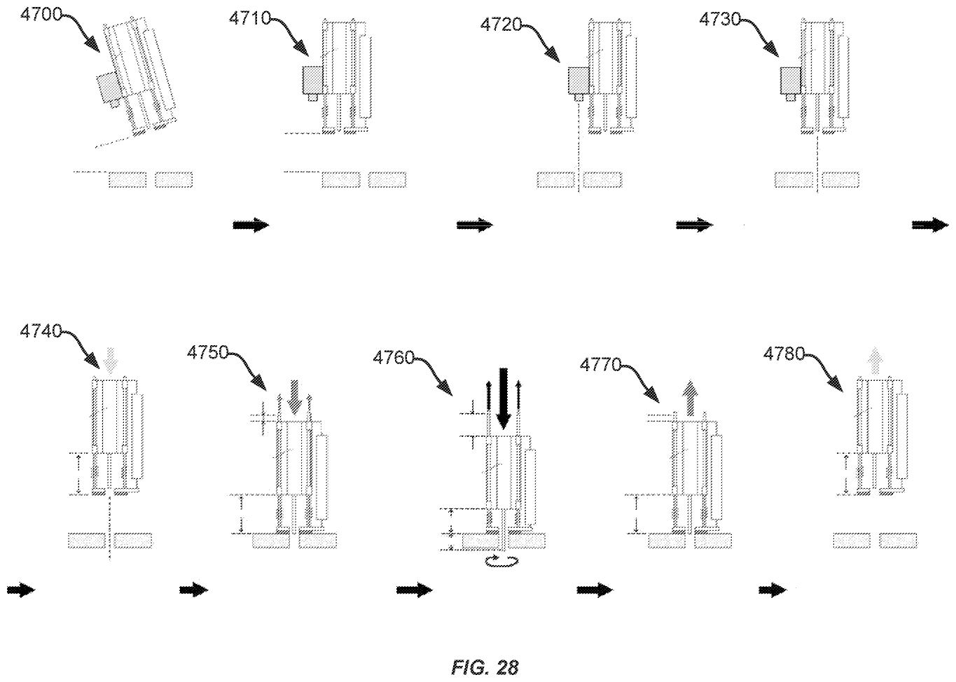

FIG. 28 is a flow chart diagram of a machining end-effector applying a machining process to a pre-drilled hole of a workpiece according to some aspects of the present disclosure. The machining end-effector can include a main part and a detachable subpart. The main part can include a spindle motor, a camera, and a machining bit. The subpart can include linear slides, a linear potentiometer, and an anti-slip rubber pad that can contact the workpiece and reduce vibrations during the machining process.

The machining process can involve, at image 4700, detecting and localizing the workpiece. Using the camera, the end-effector can be aligned, at image 4710, with one end of the workpiece so that the edge of the rubber pad aligns with an edge at the end of the workpiece. The Cobot system can move the machining end-effector to detect and localize, at image 4720, a pre-drilled target hole in the workpiece. The end-effector can be aligned, at image 4730, with the pre-drilled hole. In some examples, the end-effector can be aligned so that the machining bit is in line with a central axis defining the pre-drilled target hole. The Cobot system, at image 4740, can advance the machining end-effector towards the pre-drilled hole and the workpiece. The end-effector and the workpiece can come into contact, at image 4750, and the end-effector can passively align (as described in FIG. 7) the machining bit with the central axis of the pre-drilled target hole. An anti-slip rubber pad or a vacuum suction cup at the end of the end-effector and in contact with the workpiece can suppress system vibration for stable performance.

The end-effector can complete the machining process, at image 4760, on the pre-drilled hole. Completing the process can involve monitoring a depth of the machining bit with the linear potentiometer. For example, when the machining process is a deburring process, the linear potentiometer can detect when the machining bit is in a correct depth for deburring a top surface of the hole, causing the end-effector to stop advancing the machining bit and activate the spindle motor until the top surface is deburred. The machining bit can be advanced to a second depth that is appropriate for deburring a back surface of the hole. The potentiometer can detect when the machining bit is at this second depth, causing the end-effector to stop advancing the machining bit and activate the spindle motor until the top surface is deburred. In some examples, the motor can rotate the machining bit with a rotation speed set to a predefined rotation speed and the Cobot system can achieve specific machining profiles on both sides of the specified hole by advancing and retreating the machining bit. Once the end-effector has completed the machining process for the target hole, the end effector can retract, at image 4770, and move to a different target hole or different workpiece and repeat the machining process, at image 4780, on other pre-drilled holes.

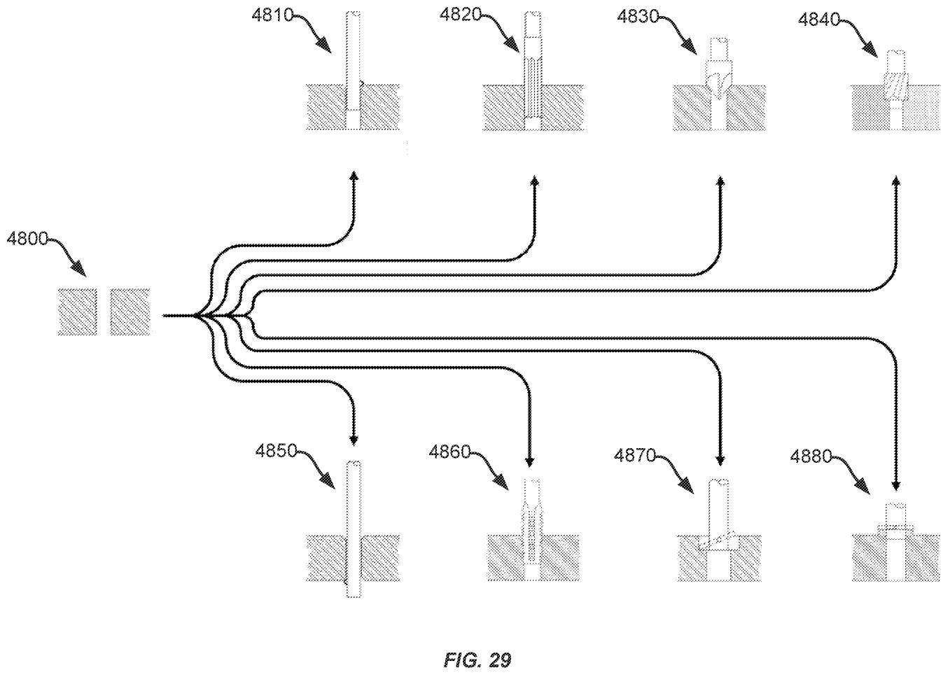

FIG. 29 is a flow chart diagram depicting a variety of machining processes performed by a machining end-effector to a pre-drilled hole 4800 of a workpiece according to some aspects of the present disclosure. Examples of machining processes that the machining end-effector can perform can include single-side deburring 4810, double-side deburring 4850, reaming 4820, countersinking 4830, counterboring 4840, boring 4870, soft facing 4880, and tapping 4860. Reaming 4820 can involve correcting a hole diameter of the pre-drilled hole 4800. Countersinking 4830 can involve producing cone shape enlargements at ends of the pre-drilled hole 4800. Counterboring 4840 can involve producing cylindrical enlargements at the ends of pre-drilled holes. Boring 4870 can involve correcting a roundness of the pre-drilled hole 4800. Soft-facing 4880 can involve producing a flat seat for a bolt head, washer, or nut at an opening of the pre-drilled hole 4800. Tapping 4860 can involve producing internal threads within the pre-drilled hole 4800.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a machining end-effector for a Cobot system, the machining end-effector comprising:
a main part comprising:
a machining bit extendable from the main part; and
a motor for rotating the machining bit; and
a subpart comprising:
a linear guiding mechanism configured to passively align the machining bit by generating a reaction torque that utilizes a compliance of the Cobot system.

2. The system of claim 1, wherein the subpart further comprises a displacement sensor configured to monitor a displacement of the machining bit along an axis of a specified hole.

3. The system of claim 1, wherein the linear guiding mechanism comprises:
four compression spring-loaded rods;
linear bearings;
linear sliders; and
a contact plate.

4. The system of claim 3, wherein the four compression spring-loaded rods are configured to produce the reaction torque by generating an unbalanced force distribution in the machining end-effector.

5. The system of claim 3, wherein the contact plate comprises a rubber pad configured to minimize slippage and prevent corrosion due to metal-metal contact.

6. The system of claim 3, wherein the contact plate comprises a vacuum suction cup with anti-slip treatment configured to minimize slippage and prevent corrosion due to metal-metal contact.

7. The system of claim 3, wherein the machining end-effector is configured to complete at least one machining process to a specified hole and wherein the four compression spring-loaded rods are configured to return the subpart to a home position after completing the at least one machining process.

8. The system of claim 7, wherein the at least one machining process comprises single-side deburring, double-side deburring, boring, counterboring, tapping, soft facing, countersinking, or reaming.

9. The system of claim 1, wherein the main part further comprises a camera configured to align the machining end-effector with a specified hole.

10. The system of claim 1, wherein the motor is configured to rotate the machining bit with a rotation speed set to a predefined rotation speed and the Cobot system is configured to achieve specific machining profiles on both sides of the specified hole by advancing and retreating the machining bit.

11. The system of claim 10, wherein the machining end-effector further comprises a rotational speed sensor embedded in the motor, the rotational speed sensor configured to monitor the rotation speed of the machining bit.

12. The system of claim 2, wherein the Cobot system comprises joints configured to monitor a displacement of the machining bit along the axis of a specified hole via torques measured at the joints.

13. The system of claim 12, wherein the Cobot system is configured to estimate a contact force based on the torques measured at the joints and monitor an advancement of the machining bit along the axis of the specified hole using the contact force.

14. The system of claim 13, wherein the Cobot system is further configured to detect faults or abnormalities based on a comparison of the contact force to readings from the displacement sensor.

15. A method for machining a specified hole with a Cobot system, the method comprising:
localizing a workpiece;
localizing a specified hole on the workpiece;
aligning a machining bit of a machining end-effector with an axis of the specified hole;
passively aligning the machining bit using a linear guidance mechanism of the machining end-effector;
advancing the machining bit towards the specified hole; and
completing at least one machining process to the specified hole.

16. The method of claim 15, further comprising monitoring a depth of the machining bit with a displacement sensor.

17. The method of claim 15, wherein passively aligning the machining bit comprises passively aligning the machining bit by generating a reaction torque that utilizes a compliance of the Cobot system.

18. The method of claim 17, wherein the linear guidance mechanism comprises:
four compression spring-loaded rods;
linear bearings;
linear sliders; and
a contact plate.

19. The method of claim 18, wherein the reaction torque is produced by the four compression spring-loaded rods by generating an unbalanced force distribution in the machining end-effector.

20. The method of claim 15, wherein a contact plate of the machining end-effector comprises a rubber pad that minimizes slippage and prevents corrosion due to metal-metal contact.
